(19) United States
(12) Patent Application Publication
(10) Pub. No.: US 2026/0154333 A1
(43) Pub. Date: Jun. 4, 2026

(54) INFORMATION PROCESSING DEVICE, INFORMATION PROCESSING METHOD, AND RECORDING MEDIUM

(71) Applicant: NEC Corporation, Tokyo (JP)

(72) Inventors: Taku FUJITOMI, Tokyo (JP); Makoto Terao, Tokyo (JP); Takashi Shibata, Tokyo (JP); Naoya Sogi, Tokyo (JP)

(73) Assignee: NEC Corporation, Tokyo (JP)

(21) Appl. No.: 19/381,396

(22) Filed: Nov. 6, 2025

(30) Foreign Application Priority Data
Nov. 29, 2024 (JP) 2024-208398

(51) Int. Cl. G06F 16/58

(52) U.S. Cl. CPC G06F 16/5866

(57) ABSTRACT

In order to provide an information processing device capable of retrieving an image corresponding to an input text with high precision, at least one processor of an information device acquires a text and an image to be compared. The processor calculates a score indicating a matching degree between the text and the image. The processor calculates a correction value of the score using a correction model, based on the image. The processor corrects the score using the correction value and outputting the corrected score. The processor trains the correction model in such a way as to optimize the correction value.

### INCORPORATION BY REFERENCE

This application is based upon and claims the benefit of priority from Japanese Patent Application 2024-208398, filed on Nov. 29, 2024, the disclosure of which is incorporated herein in its entirety by reference.

### TECHNICAL FIELD

The present disclosure relates to image retrieval.

### BACKGROUND ART

A method for retrieving a desired image from a large number of images has been proposed. For example, Patent Document 1 describes a method for retrieving a target image that matches a retrieval text, based on the retrieval text.
Patent Document 1: Japanese Patent Application Laid-Open under No. 2022-191412

### SUMMARY

The method disclosed in Patent Document 1 selects a target image based on a similarity score computed between a retrieval text and a plurality of images to be retrieved. As a result, the accuracy of the image retrieval depends heavily on a method used for calculating the similarity. Therefore, in a case where the similarity score varies according to certain characteristics of the target images, such as the way in which an object is represented or depicted in the image, the accuracy of the retrieval may be adversely affected.

One of the objects of the present disclosure is to provide an information processing device capable of retrieving an image corresponding to an input text with high precision.

According to an example aspect of the present invention, there is provided an information processing device including:
at least one memory configured to store instructions; and
at least one processor configured to execute the instructions to:
acquire a text and an image to be compared;
calculate a score indicating a matching degree between the text and the image;
calculate a correction value of the score using a correction model, based on the image;
correct the score using the correction value and outputting the corrected score; and
train the correction model in such a way as to optimize the correction value.

According to another example aspect of the present invention, there is provided an information processing method performed by a computer, the method including:
acquiring a text and an image to be compared;
calculating a score indicating a matching degree between the text and the image;
calculating a correction value of the score using a correction model, based on the image;
correcting the score using the correction value and outputting the corrected score; and
training the correction model in such a way as to optimize the correction value.

According to still another example aspect of the present invention, there is provided a non-transitory computer-readable recording medium storing a program for causing a computer to execute processing including:
acquiring a text and an image to be compared;
calculating a score indicating a matching degree between the text and the image;
calculating a correction value of the score using a correction model, based on the image;
correcting the score using the correction value and outputting the corrected score; and
training the correction model in such a way as to optimize the correction value.

### EFFECT

According to the present disclosure, an information processing device can be provided that is capable of retrieving an image corresponding to an input text with high precision.

### BRIEF DESCRIPTION OF THE DRAWINGS

FIG. 1 illustrates an overall configuration of an image retrieval system according to one example of the present disclosure;

FIG. 2 is a block diagram illustrating a hardware configuration of an information processing device;

FIG. 3 is a block diagram illustrating a functional configuration of a training device;

FIG. 4 is a block diagram illustrating a functional configuration of the information processing device;

FIG. 5 is a block diagram illustrating a functional configuration of another training device;

FIG. 6 is a block diagram illustrating a functional configuration of another information processing device;

FIG. 7 is a block diagram illustrating a functional configuration of still another training device;

FIG. 8 is a block diagram illustrating a functional configuration of still another information processing device;

FIG. 9 is a flowchart of training processing;

FIG. 10 is a flowchart of image retrieval processing;

FIGS. 11A and 11B are diagrams for explaining a calculation example of a matching score;

FIG. 12 is another diagram for explaining the calculation example of the matching score;

FIG. 13 is a block diagram illustrating a functional configuration of yet another information processing device; and

FIG. 14 is a flowchart of processing by the another information processing device.

### EXAMPLE EMBODIMENTS

Hereinafter, preferred example embodiments of the present disclosure will be described with reference to the drawings.

### Outline Description

As a method for performing image retrieval using a text as an input, a method using a similarity between an input text and a target image has been known. However, depending on a similarity calculation method, an obtained score of the similarity may be affected by content or features of an image. For example, in a case where a cosine similarity is used, even if an object indicated by a text is imaged in an image, if an object other than the object is imaged in the image, there is a case where the obtained score of the similarity is lowered. Even in a case where a similarity other than the cosine similarity is used, depending on a position, a size, how the object is imaged, or the like of the object in the image, the obtained score of the similarity may vary. Therefore, in the following example embodiment, by correcting the score of the similarity based on a feature of an image, accuracy of image retrieval is improved.

### First Example Embodiment

### Overall Configuration

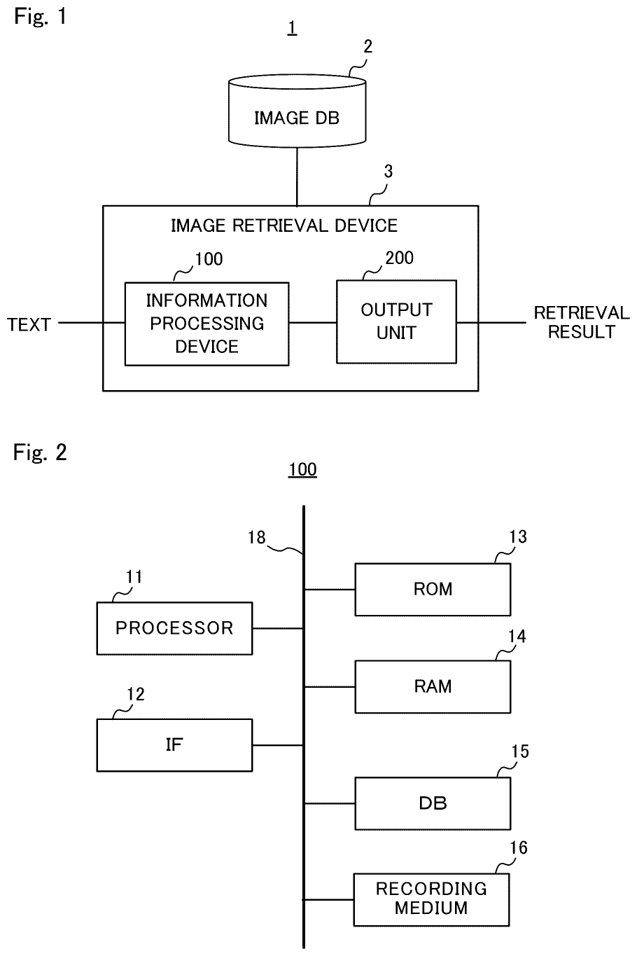

FIG. 1 illustrates an overall configuration of an image retrieval system according to one example of the present disclosure. An image retrieval system 1 retrieves an image related to a text input by a user. As illustrated in FIG. 1, the image retrieval system 1 includes an image database (hereinafter, “database” is referred to as “DB”) 2 and an image retrieval device 3. The image retrieval device 3 includes an information processing device 100 and an output unit 200.

The image DB 2 stores a plurality of images to be retrieved. The image DB 2 may store a feature amount (hereinafter, referred to as “image feature”) extracted from each image, in association with the plurality of images.

In a case where the user inputs a text indicating a retrieval target, the information processing device 100 acquires an image that matches the input text from the image DB 2 and outputs the image as a retrieval result. Although details will be described later, the information processing device 100 calculates a matching (consistency) score between the input text and the plurality of images stored in the image DB 2 and outputs the matching score to the output unit 200. The output unit 200 acquires a predetermined number of images with a high matching score from the image DB 2 and outputs the images as the retrieval result. For example, the output unit 200 arranges k images in descending order of the matching score and outputs the k images to a display device or the like.

### Hardware Configuration

FIG. 2 is a block diagram illustrating a hardware configuration of the information processing device 100. As illustrated, the information processing device 100 includes a processor 11, an interface (IF) 12, a read only memory (ROM) 13, a random access memory (RAM) 14, a database (DB) 15, and a recording medium 16. The components are connected through, for example, a bus 18.

The processor 11 is a computer such as a central processing unit (CPU) that controls the entire information processing device 100 by executing a program prepared in advance. Specifically, the processor 11 may be a CPU, a graphics processing unit (GPU), a digital signal processor (DSP), a microprocessing unit (MPU), a floating point processing unit (FPU), a physics processing unit (PPU), a tensor processing unit (TPU), a quantum processor, a microcontroller, or a combination thereof.

The processor 11 loads a program stored in the ROM 13 or the recording medium 16 into the RAM 14 and executes each process coded in the program. The processor 11 functions as part or all of the information processing device 100. Specifically, the processor 11 executes training processing and image retrieval processing described later.

The IF 12 transmits and receives data to and from an external device. Specifically, the information processing device 100 acquires the text input by the user through the IF 12. The information processing device 100 accesses the image DB 2 via the IF 12 and acquires the images and the image features. The information processing device 100 outputs the image retrieval result to the display device or another external device through the IF 12.

The ROM 13 stores various programs executed by the processor 11. The RAM 14 is used as a working memory during execution of various types of processing by the processor 11.

The DB 15 stores various algorithms, data, machine learning models, or the like to be used in a case where the information processing device 100 executes the training processing and the image retrieval processing to be described later.

The recording medium 16 is a non-volatile non-transitory recording medium such as a disk-shaped recording medium or a semiconductor memory. The recording medium 16 may be attachable to and detachable from the information processing device 100. The recording medium 16 records various programs executed by the processor 11.

In addition to the above, the information processing device 100 may include a display device such as a liquid crystal display and an input device such as a keyboard and a mouse. These display devices and input devices are used by an operator of the information processing device 100, for example.

### First Example

### Training Device

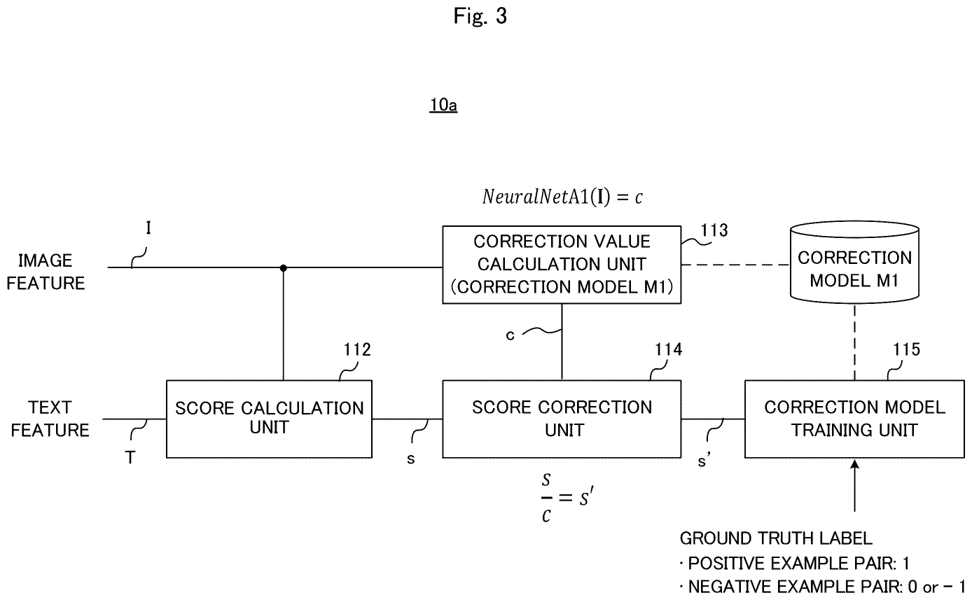

FIG. 3 is a block diagram illustrating a functional configuration of a training device according to a first example. This training device is a device for training a correction model that calculates a correction value of the matching score. As illustrated, a training device 10a includes a score calculation unit 112, a correction value calculation unit 113, a score correction unit 114, and a correction model training unit 115.

Training data is input into the training device 10a. The training data includes a feature amount (hereinafter, referred to as “text feature”) related to a text, an image feature related to an image, and a ground truth label related to a pair of the text feature and the image feature (hereinafter, referred to as “text-image pair”). Specifically, in a case where an object indicated by a text is imaged in an image, in one text-image pair, since the text and the image match (match), the text-image pair is referred to as a “positive example pair”, and a value indicating the positive example pair (for example, “1”) is given as the ground truth label. On the other hand, in a case where an object indicated by a text is not imaged in an image, in one text-image pair, since the text and the image do not match, the text-image pair is referred to as a “negative example pair”, and a value indicating the negative example pair (for example, “0”, “−1”, or the like) is given as the ground truth label.

At the time of training, the training data described above is input to the training device 10a. Specifically, a text feature T is input to the score calculation unit 112, and an image feature I is input to the score calculation unit 112 and the correction value calculation unit 113.

The score calculation unit 112 calculates a matching score s between the image feature I and the text feature T and outputs the matching score s to the score correction unit 114. The matching score s is a score indicating a matching degree between the image feature I and the text feature T. Basically, if the object indicated by the text feature T is imaged in the image, the matching score s is high, and the object is not imaged in the image, the matching score s is low. For example, the score calculation unit 112 calculates a cosine similarity between the image feature I and the text feature T as the matching score s. The score calculation unit 112 may calculate a similarity other than the cosine similarity as the matching score s.

The correction value calculation unit 113 calculates a correction value c of the matching score s, based on the input image feature I and outputs the correction value c to the score correction unit 114. Specifically, the correction value calculation unit 113 calculates the correction value c using a correction model M1 which is a machine learning model. The correction value c is a value that reduces an influence of surrounding environment of a target to be retrieved in the image on the matching score. For example, the correction model M1 includes a neural network and is expressed as follows.

$$NeuralNetA 1 ( I ) = c \qquad ( 1 )$$

The score correction unit 114 corrects the matching score s using the correction value c. Specifically, the score correction unit 114 corrects the matching score s using the following correction formula and calculates a corrected matching score s′.

$$s / c = {s}^{′} \qquad ( 2 )$$

As described above, since the score correction unit 114 uses the correction formula with a small calculation amount, it is possible to suppress a calculation load required for correcting the matching score s. The score correction unit 114 outputs the corrected matching score s′ to the correction model training unit 115. The corrected matching score s′ is a score with which the influence of the surrounding environment of the target to be retrieved in the image on the matching score is reduced. In the following description, the matching score s before correction may be referred to as “matching score s before correction” to be distinguished from the corrected matching score s′.

The correction model training unit 115 optimizes the correction model M1 using the corrected matching score s′ and the ground truth label described above. Specifically, the correction model training unit 115 updates the correction model M1 by a gradient descent, in such a way as to minimize an error between the corrected matching score s′ and the ground truth label.

In this way, the correction model M1 is trained using the training data prepared in advance. In a case where a predetermined training end condition is satisfied, the training ends, and the trained correction model M1 is obtained.

### Information Processing Device

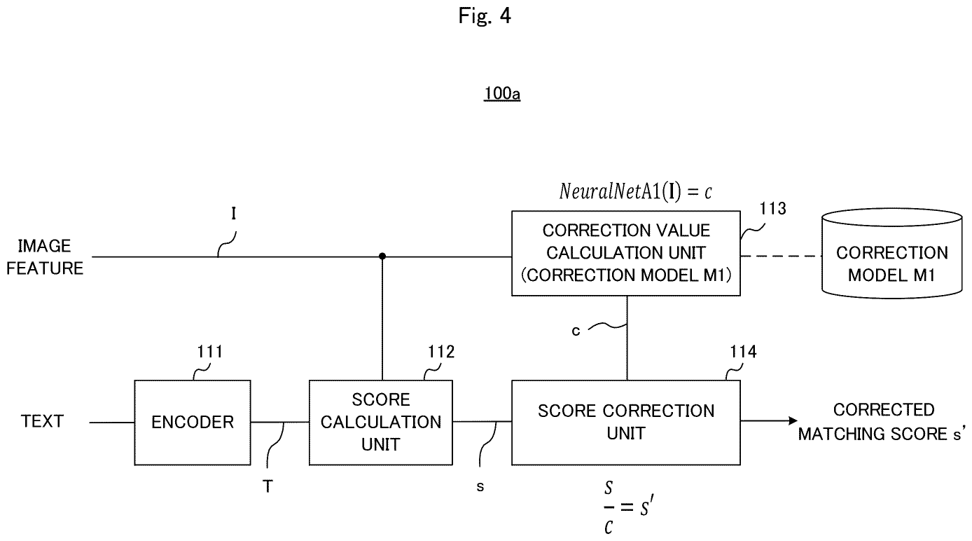

Next, an information processing device that performs inference using the correction model M1 trained by the training device 10a described above will be described. The inference here refers to calculating a corrected matching score between a text input by a user and an image. FIG. 4 is a block diagram illustrating a functional configuration of an information processing device 100a. As illustrated, the information processing device 100a includes an encoder 111, the score calculation unit 112, the correction value calculation unit 113, and the score correction unit 114. Here, the score calculation unit 112 and the score correction unit 114 are the same as those of the training device 10a illustrated in FIG. 3. The correction value calculation unit 113 uses the correction model M1 trained by the training device 10a.

At the time of image retrieval, the text input by the user is input to the encoder 111. An image feature of an image to be compared, acquired from the image DB 2 is input to the score calculation unit 112 and the correction value calculation unit 113. The encoder 111 converts the input text into the text feature T and outputs the text feature T to the score calculation unit 112. The score calculation unit 112 calculates the cosine similarity between the text feature T and the image feature I or the like as the matching score s and outputs the matching score s to the score correction unit 114.

On the other hand, the correction value calculation unit 113 calculates the correction value c from the image feature I, using the trained correction model M1 and outputs the correction value c to the score correction unit 114. The score correction unit 114 corrects the matching score s using the correction value c, according to the correction formula (2) described above and outputs the corrected matching score s′. In this way, the corrected matching score s′ between the text input by the user and the single image is obtained. The information processing device 100a executes this processing on a plurality of images and outputs a corrected matching score s′ of each image.

Since an image to be a target of image retrieval is, for example, an image determined in advance, such as the image stored in the image DB 2, before starting actual inference processing, it is possible to calculate the correction value c related to each image using the trained correction model M1 and store the correction value c in a memory or the like in association with the image or the image feature. In this way, in the actual inference processing, it is sufficient for the correction value calculation unit 113 to acquire the correction value c calculated in advance from the memory, instead of calculating the correction value c for each image, and a time required for actual image retrieval can be shortened.

As described above, according to the first example, since the correction model M1 is trained using the training data including the positive example pair and the negative example pair and the correction value c is calculated using the trained correction model M1, it is possible to calculate the corrected matching score s′ related to the text input by the user with high accuracy.

### Second Example

### Training Device

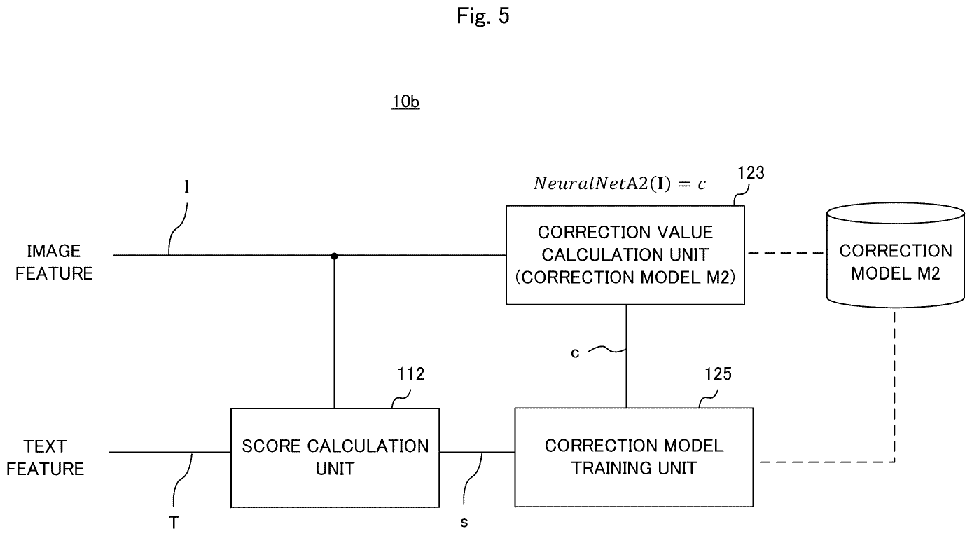

FIG. 5 is a block diagram illustrating a functional configuration of a training device according to a second example. This training device is a device for training a correction model that calculates a correction value of the matching score. As illustrated, a training device 10b includes the score calculation unit 112, a correction value calculation unit 123, and a correction model training unit 125.

In the second example, the correction model calculates a predicted value of the matching score based only on the image feature. Therefore, in the second example, a positive example pair, that is, a pair of an image feature and a text feature of a positive example is used, as the training data. In the second example, the training data does not need to include the ground truth label as in the first example.

The text feature T included in the training data is input to the score calculation unit 112, and the image feature I is input to the score calculation unit 112 and the correction value calculation unit 123. The score calculation unit 112 is basically the same as that in the first example, and calculates the matching score s between the image feature I and the text feature T and outputs the matching score s to the correction model training unit 125.

The correction value calculation unit 123 calculates the correction value c of the matching score s based on the input image feature I and outputs the correction value c to the correction model training unit 125. Specifically, the correction value calculation unit 113 calculates the correction value c using a correction model M2 which is a machine learning model. Here, unlike the first example, the correction model M2 is trained to output a predicted value of the matching score s output by the score calculation unit 112, based on only the input image feature I. In other words, the correction model M2 is trained to predict and output a tendency of a magnitude of the matching score caused by the image. From this point, in the second example, the correction value c relates to the predicted value of the matching score, and hereinafter, this is referred to as a “predicted matching score c”. For example, the correction model M2 includes a neural network and is expressed as follows.

$$NeuralNetA 2 ( I ) = c \qquad ( 3 )$$

The correction model training unit 125 optimizes the correction model M2, using the matching score s input from the score calculation unit 112 and the predicted matching score c input from the correction value calculation unit 123. Specifically, the correction model training unit 125 updates the correction model M2 by the gradient descent, in such a way as to minimize an error between the matching score s and the predicted matching score c.

In this way, the correction model M2 is trained using the training data prepared in advance. In a case where a predetermined training end condition is satisfied, the training ends, and the trained correction model M2 is obtained.

### Information Processing Device

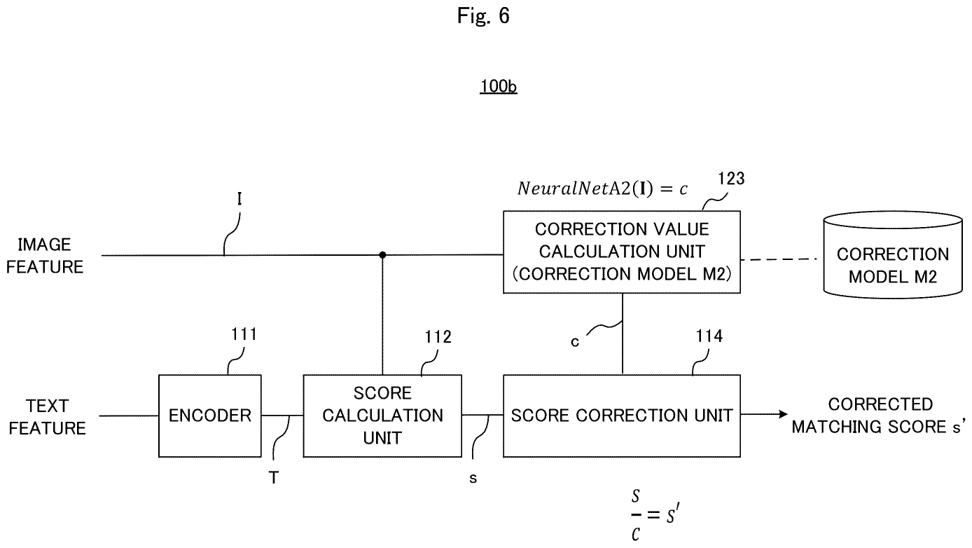

Next, an information processing device that performs inference using the correction model M2 trained by the training device 10b described above will be described. The inference here refers to calculating a corrected matching score between a text input by a user and an image. FIG. 6 is a block diagram illustrating a functional configuration of an information processing device 100b. As illustrated, the information processing device 100b includes the encoder 111, the score calculation unit 112, the correction value calculation unit 123, and the score correction unit 114. Here, the encoder 111, the score calculation unit 112, and the score correction unit 114 are the same as those of the information processing device 100a in the first example illustrated in FIG. 4. The correction value calculation unit 123 uses the correction model M2 trained by the training device 10b.

At the time of image retrieval, the text input by the user is input to the encoder 111. The image feature of the image to be compared, acquired from the image DB 2 is input to the score calculation unit 112 and the correction value calculation unit 123. The encoder 111 converts the input text into the text feature T and outputs the text feature T to the score calculation unit 112. The score calculation unit 112 calculates the cosine similarity between the text feature T and the image feature I or the like as the matching score s and outputs the matching score s to the score correction unit 114.

On the other hand, the correction value calculation unit 123 calculates the predicted matching score c (correction value c) from the image feature I, using the trained correction model M2 and outputs the predicted matching score c to the score correction unit 114. The score correction unit 114 corrects the matching score s using the predicted matching score c, according to the correction formula (2) and outputs the corrected matching score s′.

In the second example, since the matching score s is corrected using the predicted matching score c output from the correction model M2, the score correction unit 114 performs correction for increasing the matching score s in a case where the predicted matching score c is small and decreasing the matching score s in a case where the predicted matching score c is large. As a result, it is possible to suppress an influence of the magnitude tendency of the matching score depending on the image on a matching score to be finally output.

In this way, the corrected matching score s′ between the text input by the user and the single image is obtained. The information processing device 100b executes this processing on a plurality of images and outputs a corrected matching score s′ for each image.

In the second example, since the image to be the target of image retrieval is, for example, an image determined in advance, such as the image stored in the image DB 2, before starting the actual inference processing, it is possible to calculate the predicted matching score c related to each image using the trained correction model M2 and store the predicted matching score c in the memory or the like in association with the image or the image feature. In this way, in the actual inference processing, it is sufficient for the correction value calculation unit 123 to acquire the predicted matching score c calculated in advance from the memory, instead of calculating the predicted matching score c for each image, and a time required for actual image retrieval can be shortened.

As described above, according to the second example, since the correction model M2 is trained using the training data related to the positive example pair and the predicted matching score c is calculated using the trained correction model M2, it is possible to calculate the corrected matching score s'related to the text input by the user with high accuracy.

### Third Example

### Training Device

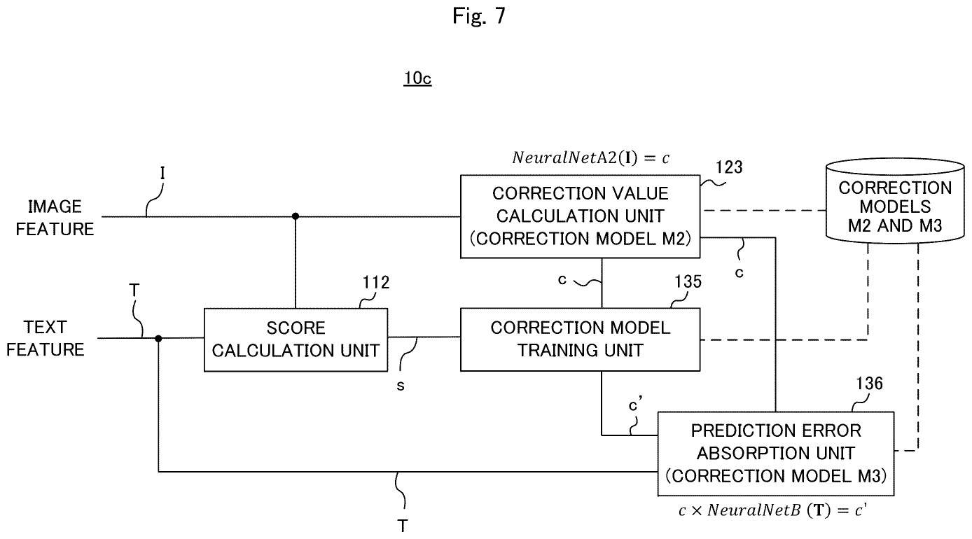

FIG. 7 is a block diagram illustrating a functional configuration of a training device according to a third example. The third example relates to a modification of the second example. As illustrated, a training device 10c includes the score calculation unit 112, the correction value calculation unit 123, a correction model training unit 135, and a prediction error absorption unit 136.

In the third example, the matching score is corrected using the correction model M2, as in the second example. In addition, in the third example, in order to absorb a prediction error caused in the correction model M2 caused by an input text, the prediction error absorption unit 136 is added. The prediction error absorption unit 136 uses a correction model M3. The correction model M3 has a role for modifying the predicted matching score c output from the correction model M2, based on the text feature T. Training data used by the training device 10c of the third example is basically similar to the training data used by the training device 10b of the second example.

The text feature T included in the training data is input to the score calculation unit 112, and the image feature I is input to the score calculation unit 112 and the correction value calculation unit 123. The score calculation unit 112 calculates the matching score s between the image feature I and the text feature T and outputs the matching score s to the correction model training unit 135. The correction value calculation unit 123 calculates the predicted matching score c using the correction model M2, based on the input image feature I and outputs the predicted matching score c to the correction model training unit 135 and the prediction error absorption unit 136.

The prediction error absorption unit 136 has a role for absorbing a prediction error of the predicted matching score c caused by the text feature T, that is, a variation. Even in a case where the same image is input, if complexity of the input text or the like differs, a matching score s to be a training target of the correction model M2 varies. Therefore, the prediction error absorption unit 136 modifies the predicted matching score c output from the correction model M2 using the correction model M3, based on the text feature T and outputs a modified predicted matching score c′ to the correction model training unit 135. The correction model M3 used by the prediction error absorption unit 136 includes a neural network and is expressed as follows.

$$NeuralNetB ( T ) = c \qquad ( 4 )$$

The modified predicted matching score c′ output from the prediction error absorption unit 136 is expressed by the following formula.

$$c \times NeuralNetB ( T ) = {c}^{′} \qquad ( 5 )$$

The correction model training unit 135 optimizes the correction models M2 and M3, using the matching score s input from the score calculation unit 112, the predicted matching score c input from the correction value calculation unit 123, and the modified predicted matching score c′ input from the prediction error absorption unit 136. Specifically, the correction model training unit 135 updates the correction models M2 and M3 by the gradient descent, in such a way as to minimize a weighted sum between a first error between the matching score s and the predicted matching score c and a second error between the matching score s and the modified predicted matching score c′.

In this way, the correction models M2 and M3 are trained using the training data prepared in advance. In a case where a predetermined training end condition is satisfied, the training ends, and the trained correction models M2 and M3 are obtained.

### Information Processing Device

Next, an information processing device that performs inference using the correction models M2 and M3 trained by the training device 10c described above will be described. The inference here refers to calculating a corrected matching score between a text input by a user and an image. As the information processing device of the third example, the following two configuration examples are considered.

A first configuration example uses only the trained model M2. In the training device 10c, the correction model M2 is trained using the modified predicted matching score c′ output from the prediction error absorption unit 136. Therefore, in the first configuration example, inference is performed using only the correction model M2. The configuration of the information processing device in this case is similar to that of the information processing device 100b illustrated in FIG. 6. However, the trained correction model M2 used by the correction value calculation unit 123 is trained by the training device 10c illustrated in FIG. 7.

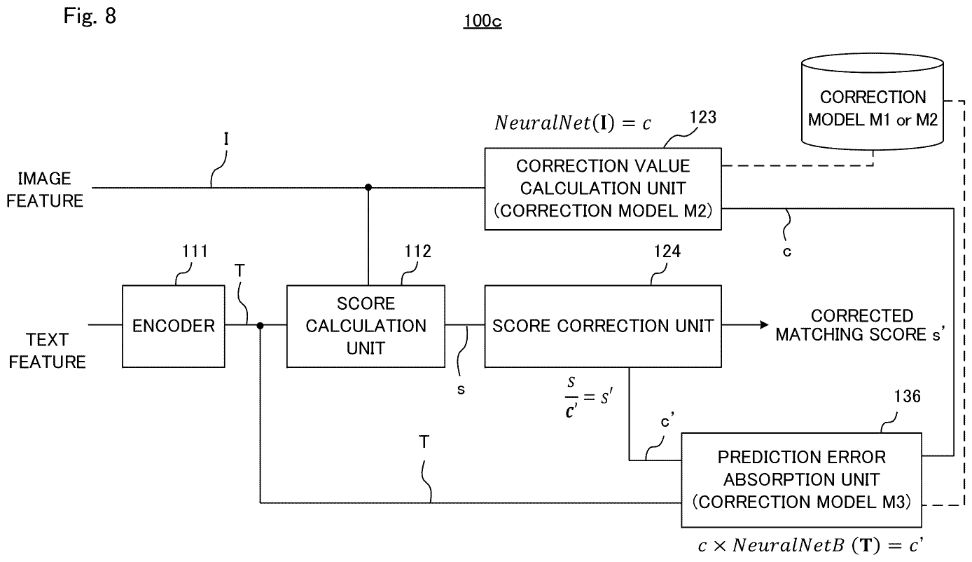

A second configuration example uses both of the trained correction models M2 and M3. FIG. 8 is a block diagram illustrating a functional configuration of an information processing device 100c according to the second configuration example of the third example. The information processing device 100c uses the correction models M2 and M3 trained by the training device 10c described above.

As illustrated, the information processing device 100c includes the encoder 111, the score calculation unit 112, the correction value calculation unit 123, a score correction unit 124, and the prediction error absorption unit 136. Here, the encoder 111 and the score calculation unit 112 are the same as those of the information processing device 100a in the first example illustrated in FIG. 4. The correction value calculation unit 123 uses the correction model M2 trained by the training device 10c. The prediction error absorption unit 136 uses the correction model M3 trained by the training device 10c.

At the time of image retrieval, the text input by the user is input to the encoder 111. The image feature of the image to be compared, acquired from the image DB 2 is input to the score calculation unit 112 and the correction value calculation unit 123. The encoder 111 converts the input text into the text feature T and outputs the text feature T to the score calculation unit 112 and the prediction error absorption unit 136. The score calculation unit 112 calculates the cosine similarity between the text feature T and the image feature I or the like as the matching score s and outputs the matching score s to the score correction unit 124.

On the other hand, the correction value calculation unit 123 calculates the predicted matching score c from the image feature I, using the trained correction model M2 and outputs the predicted matching score c to the prediction error absorption unit 136. The prediction error absorption unit 136 calculates the modified predicted matching score c′ by modifying the predicted matching score c based on the text feature T, using the trained correction model M3 and outputs the modified predicted matching score c′ to the score correction unit 114.

The score correction unit 124 corrects the matching score s using the modified predicted matching score c′, according to the following correction formula and outputs the corrected matching score s′.

$$s / {c}^{′} = {s}^{′} \qquad ( 5 )$$

In this way, the corrected matching score s′ between the text input by the user and the single image is obtained. The information processing device 100b executes this processing on a plurality of images and outputs a corrected matching score s′ for each image.

In the third example, since the matching score s is corrected using the modified predicted matching score c′ output from the correction model M3, the errors and the variations in the matching score caused by the text can be absorbed. Therefore, the corrected matching score s′ related to the text input by the user can be calculated with high accuracy.

### Training Processing

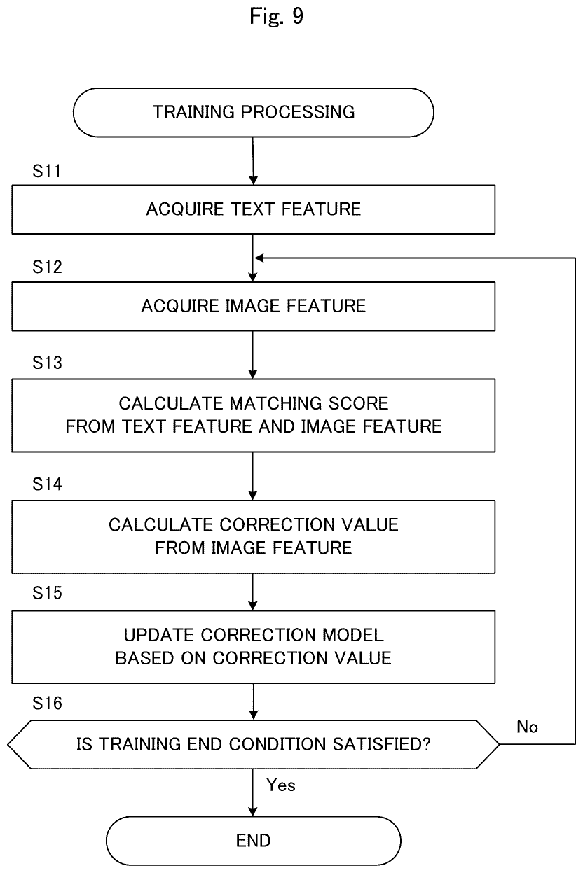

Next, the training processing by the training devices 10a to 10c in the first to third examples will be described. FIG. 9 is a flowchart of processing of the training processing by the training devices 10a to 10c. This processing is achieved by the processor 11 illustrated in FIG. 2 executing a program prepared in advance and operating as each element illustrated in FIGS. 3, 5, or 7. In the following description, in a case where the training devices 10a to 10c are not distinguished from each other, the training devices 10a to 10c are represented as a “training device 10”.

First, the training device 10 acquires the text feature included in the training data (step S11), and acquires the image feature related to the text feature (step S12). Next, the training device 10 calculates the matching score s from the text feature and the image feature (step S13). Next, the training device 10 calculates the correction value c from the image feature (step S14). At this time, in the first example, the training device 10a calculates the correction value c. In the second and third examples, the training devices 10b and 10c calculate the predicted matching score c.

Next, the training device 10 updates the correction model based on the correction value (step S15). At this time, in the first example, the training device 10a updates the correction model M1. In the second example, the training device 10b updates the correction model M2. In the third example, the training device 10c updates the correction models M2 and M3.

Next, the training device 10 determines whether the predetermined training end condition is satisfied (step S16). The predetermined training end condition is, for example, that training is performed using all pieces of training data prepared in advance. In a case where the training end condition is not satisfied (step S16: No), the processing returns to step S12, and steps S12 to S15 are executed on a next piece of the training data. On the other hand, in a case where the training end condition is satisfied (step S16: Yes), the training processing ends.

### Image Retrieval Processing

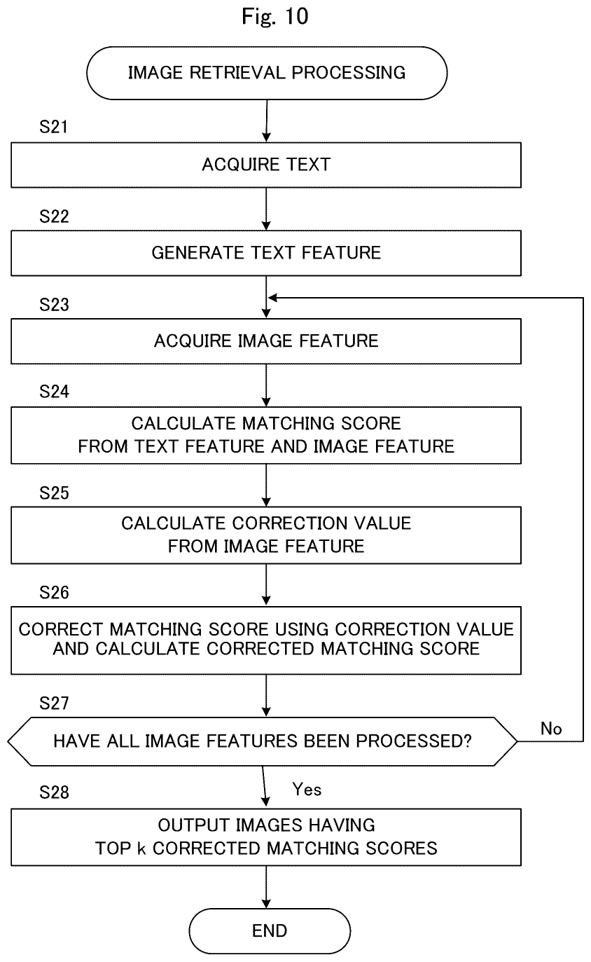

Next, image retrieval processing by the image retrieval device 3 including the information processing device in the first to third examples will be described. FIG. 10 is a flowchart of the image retrieval processing by the image retrieval device 3 including the information processing devices 100a to 100c. This processing is achieved by the processor 11 illustrated in FIG. 2 executing a program prepared in advance and operating as each element illustrated in FIGS. 4, 6, or 8. In the following description, in a case where the information processing devices 100a to 100c are not distinguished from each other, the information processing devices 100a to 100c are represented as an “information processing device 100”.

First, the information processing device 100 acquires the text input by the user (step S21) and generates the text feature from the text (step S22). Next, the information processing device 100 acquires a single image feature to be compared (step S23). Next, the information processing device 100 calculates the matching score s from the text feature and the image feature (step S24).

Next, the information processing device 100 calculates the correction value c from the image feature (step S25). At this time, in the first example, the information processing device 100a calculates the correction value c using the correction model M1. In the second example, the information processing device 100b calculates the predicted matching score c using the correction model M2. In the third example, the information processing device 100c calculates the predicted matching score c using the correction model M2 or calculates the modified predicted matching score c′ using the correction models M2 and M3.

Next, the information processing device 100 corrects the matching score s using the correction value and calculates the corrected matching score s′ (step S26). At this time, in the first and second examples, the information processing devices 100a and 100b correct the matching score s using the correction value c or the predicted matching score c. In the third example, the information processing device 100c corrects the matching score s using the predicted matching score c or the modified predicted matching score c′.

Next, the information processing device 100 determines whether the image features of all the images to be retrieved have been processed (step S27). In a case where all the image features have not been processed (step S27: No), the processing returns to step S23, and steps S23 to S26 are executed on a next image feature. On the other hand, in a case where all the image features have been processed (step S27: Yes), the information processing device 100 outputs the corrected matching scores s′ calculated for all the image features to the output unit 200 of the image retrieval device 3. The output unit 200 outputs images having top k corrected matching score s′ to the display device or the external device together with the corrected matching score s′ (step S28). Then, the image retrieval processing ends.

### Calculation Example of Matching Score

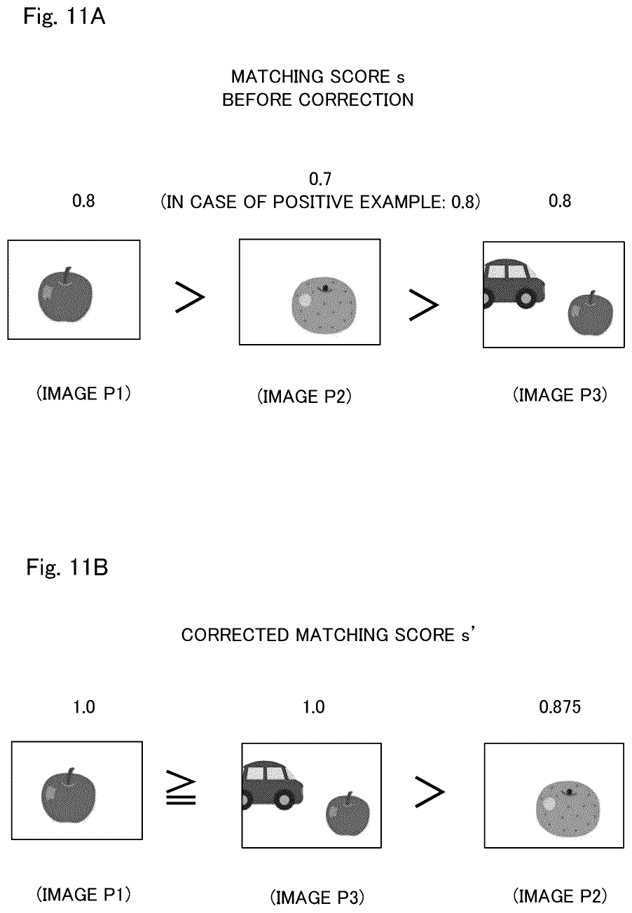

Next, a calculation example of the matching score will be described. Now, as illustrated in FIG. 11A, as an image to be compared, it is assumed that there be an image P1 in which only an apple is imaged, an image P2 in which only an orange is imaged, and an image P3 in which an apple and a car are imaged. It is assumed that a matching score s before correction calculated by the score calculation unit 112 in a case where a text “apple” is input be “0.8” for the image P1, “0.7” for the image P2, and “0.6” for the image P3. Although the matching score s before correction=0.7 because the text is “apple” in the image P2, in a case where the text is “orange”, that is, in a case where the text and the image are a positive example pair, it is assumed that the matching score s before correction be “0.8”.

In a case in FIG. 11A, the matching scores s before correction for the text “apple” satisfy the image P1>the image P2>the image P3. In this example, an apple is not imaged in the image P2, and an apple is imaged in the image P3. However, since not only an apple but also a car are imaged in the image P3, the score calculation unit 112 calculates a higher matching score s for the image P2 in which the apple is not imaged, than the image P3 in which the apple is imaged. As described above, in a case where the matching score is calculated based on the similarity, accuracy of the matching score may be lowered, depending on content of the image or the like.

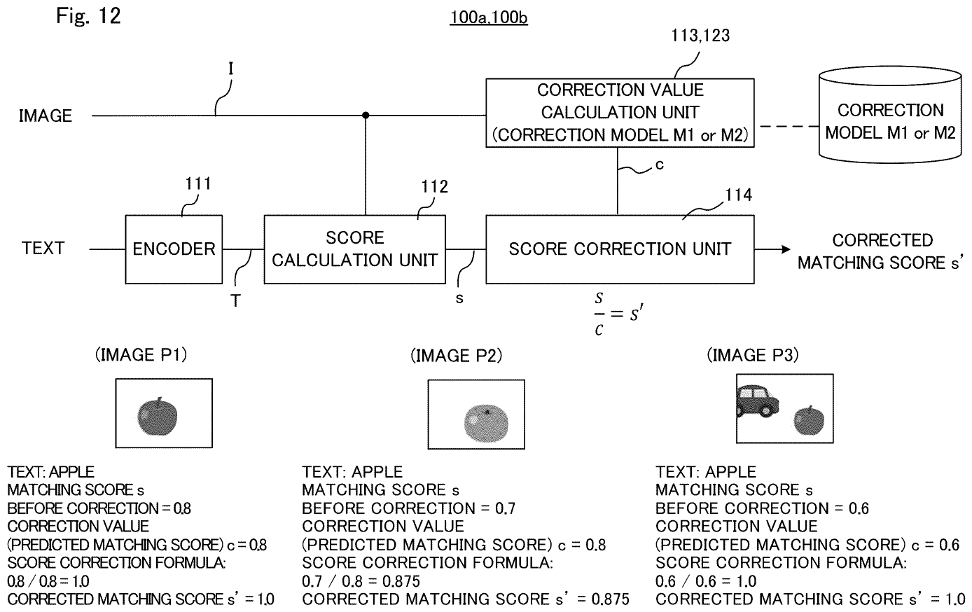

FIG. 12 is a diagram for explaining a correction example of the matching score in this case. As illustrated, a case will be considered where the matching scores for the images P1 to P3 are corrected, using the information processing device 100a or 100b.

It is assumed that the image P1 be an image including only an apple and a text input by the user be “apple”. In this case, the matching score s before correction=0.8, and the correction value (predicted matching score) c=0.8. Therefore, the corrected matching score s′=1.0.

It is assumed that the image P2 be an image including only an orange and a text input by the user be “apple”. In this case, the matching score s before correction=0.7. As illustrated in FIG. 11A, a correction value (predicted matching score) c calculated by the correction value calculation unit 113 or 123 based on only the image P2=0.8. Therefore, the corrected matching score s′=0.875.

It is assumed that the image P3 be an image including an apple and a car and a text input by the user be “apple”. In this case, the matching score s before correction=0.6, and the correction value (predicted matching score) c=0.6. Therefore, the corrected matching score s′=1.0.

As described above, as illustrated in FIG. 11B, the corrected matching score s′ obtained by the information processing device 100 is the image P1≥the image P3>the image P2, and the corrected matching score s′ of the image P3 including the apple and the car is higher than that of the image P2 including only the orange. As described above, according to the information processing device 100, it is possible to suppress a decrease in the matching score caused by how an object is imaged in the image.

### Application Example

The image retrieval method according to the present disclosure can be used, for example, to grasp a disaster situation. Specifically, by inputting a text such as “houses are collapsed” or “roads are inaccessible” and retrieving an image, in order to grasp a situation of a disaster site, images of a place in such a situation can be collected.

The image retrieval method according to the present disclosure can be used, for example, for assisting police investigations in various situations. Specifically, by performing image retrieval by specifying a color of a vehicle that has been observed in a crime scene and inputting “a red vehicle” or by specifying an appearance of a person who has been observed in the crime scene and inputting “wearing a two-piece gray sweats” or other similar descriptions, it is possible to search effectively for an image of a vehicle or a person that is related to the crime.

In addition, the image retrieval method according to the present disclosure can be used, for example, in a case where a medium or the like that handles a large number of moving images collects a target image.

### Second Example Embodiment

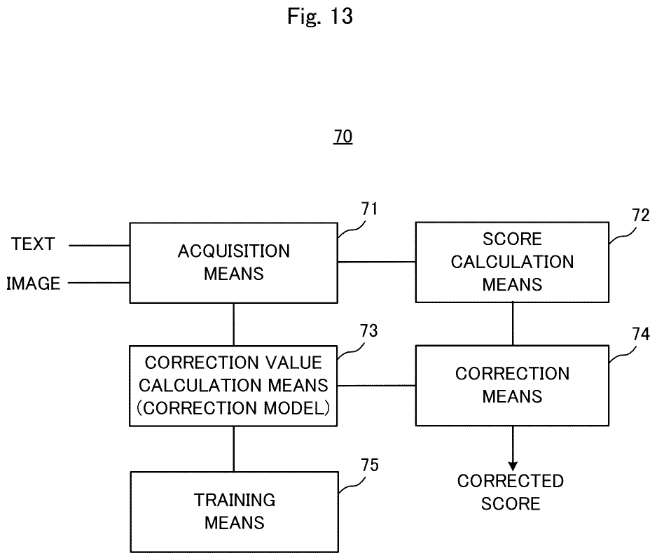

FIG. 13 is a block diagram illustrating a functional configuration of an information processing device according to a second example embodiment of the present disclosure. An information processing device 70 according to the second example embodiment includes acquisition means 71, score calculation means 72, correction value calculation means 73, correction means 74, and training means 75.

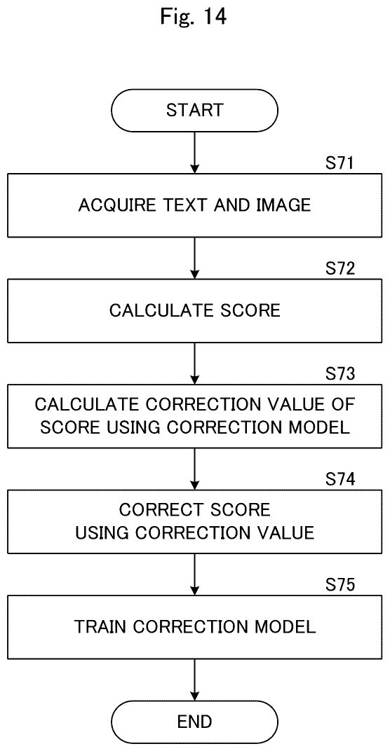

FIG. 14 is a flowchart of processing by the information processing device according to the second example embodiment. The acquisition means 71 acquires a text and an image to be compared (step S71). The score calculation means 72 calculates a score indicating a matching degree between the text and the image (step S72). The correction value calculation means 73 calculates a correction value of the score using a correction model, based on the image (step S73). The correction value of the score is a value that reduces an influence of surrounding environment of a target to be retrieved in the image on a matching score. The correction means 74 corrects the score using the correction value and outputs the corrected score (step S74). The corrected score is a score with which the influence of the surrounding environment of the target to be retrieved in the image on the score is reduced. The training means 75 trains the correction model in such a way as to optimize the correction value (step S75).

According to the information processing device 70, the image related to the input text can be retrieved with high accuracy.

Some or all of the above example embodiments may also be described as the following Supplementary Notes, but are not limited to the following.

### (Supplementary Note 1)

1. An information processing device comprising:
acquisition means configured to acquire a text and an image to be compared;
score calculation means configured to calculate a score indicating a matching degree between the text and the image;
correction value calculation means configured to calculate a correction value of the score using a correction model, based on the image;
correction means configured to correct the score using the correction value and outputting the corrected score; and
training means configured to train the correction model in such a way as to optimize the correction value.

### (Supplementary Note 2)

2. The information processing device according to Supplementary Note 1, wherein the training means trains the correction model in such a way as to minimize an error between the corrected score and a ground truth label, using training data including a text, an image, and the ground truth label indicating a matching degree between the text and the image.

### (Supplementary Note 3)

3. The information processing device according to Supplementary Note 1, wherein the training means trains the correction model in such a way as to minimize an error between a score before correction and the correction value, using a pair of a text and an image that matches the text as training data.

### (Supplementary Note 4)

4. The information processing device according to Supplementary Note 3, further comprising correction value modifying means configured to modify the correction value, based on a feature of the text.

### (Supplementary Note 5)

5. The information processing device according to Supplementary Note 4, wherein the correction means corrects the score using a modified correction value.

### (Supplementary Note 6)

6. The information processing device according to Supplementary Note 4, wherein the training means trains the correction model in such a way as to minimize a first error between a score before correction and the correction value, using a pair of a text and an image that matches the text as training data and a second error between the score before the correction and a modified correction value.

### (Supplementary Note 7)

7. The information processing device according to Supplementary Note 1, wherein the score is a similarity between the text and the image.

### (Supplementary Note 8)

8. The information processing device according to Supplementary Note 1, wherein
the acquisition means acquires a plurality of the images to be compared, and
the correction means outputs a predetermined number of images in descending order of the corrected score, among the plurality of images, as images related to the text.

### (Supplementary Note 9)

9. An information processing method performed by a computer, the method comprising:
acquiring a text and an image to be compared;
calculating a score indicating a matching degree between the text and the image;
calculating a correction value of the score using a correction model, based on the image;
correcting the score using the correction value and outputting the corrected score; and
training the correction model in such a way as to optimize the correction value.

### (Supplementary Note 10)

10. A program for causing a computer to execute processing comprising:
acquiring a text and an image to be compared;
calculating a score indicating a matching degree between the text and the image;
calculating a correction value of the score using a correction model, based on the image;
correcting the score using the correction value and outputting the corrected score; and
training the correction model in such a way as to optimize the correction value.

Some or all of the configurations described in Supplementary Notes 2 to 8, which are dependent on the above-described Supplementary Note 1, can also be dependent on Supplementary Notes 9 and 10 through a dependency relationship similar to that of Supplementary Notes 2 to 8. Furthermore, not limited to Supplementary Notes 1, 9, and 10, and within a range that does not depart from the above-described example embodiments, some or all of the configurations described in the Supplementary Notes can likewise be made dependent on various recording means, as well as on various pieces of hardware, software, or systems used for recording software.

The present disclosure has been described above with reference to example embodiments and example illustrations; however, the present disclosure is not limited to these example embodiments or illustrations. It will be understood by those of ordinary skill in the art that various changes may be made to the configurations, structures, and details of the present disclosure without departing from the scope and spirit of the present disclosure as defined by the claims.

### DESCRIPTION OF SYMBOLS

1 Image retrieval system
2 Image DB
3 Image retrieval device
11 Processor
111 Encoder
112 Score calculation unit
113, 123 Correction value calculation unit
114, 124 Score correction unit
115, 125, 135 Correction model training unit
136 Prediction error absorption unit
100 Information processing device
200 Output unit

1. An information processing device comprising:
at least one memory configured to store instructions; and
at least one processor configured to execute the instructions to:
acquire a text and an image to be compared;
calculate a score indicating a matching degree between the text and the image;
calculate a correction value of the score using a correction model, based on the image;
correct the score using the correction value and outputting the corrected score; and
train the correction model in such a way as to optimize the correction value.

2. The information processing device according to claim 1, wherein the processor trains the correction model in such a way as to minimize an error between the corrected score and a ground truth label, using training data including a text, an image, and the ground truth label indicating a matching degree between the text and the image.

3. The information processing device according to claim 1, wherein the processor trains the correction model in such a way as to minimize an error between a score before correction and the correction value, using a pair of a text and an image that matches the text as training data.

4. The information processing device according to claim 3, wherein the processor is further configured to modify the correction value, based on a feature of the text.

5. The information processing device according to claim 4, wherein the processor corrects the score using a modified correction value.

6. The information processing device according to claim 4, wherein the processor trains the correction model in such a way as to minimize a first error between a score before correction and the correction value, using a pair of a text and an image that matches the text as training data and a second error between the score before the correction and a modified correction value.

7. The information processing device according to claim 1, wherein the score is a similarity between the text and the image.

8. The information processing device according to claim 1, wherein
the processor acquires a plurality of the images to be compared, and
the processor outputs a predetermined number of images in descending order of the corrected score, among the plurality of images, as images related to the text.

9. An information processing method performed by a computer, the method comprising:
acquiring a text and an image to be compared;
calculating a score indicating a matching degree between the text and the image;
calculating a correction value of the score using a correction model, based on the image;
correcting the score using the correction value and outputting the corrected score; and
training the correction model in such a way as to optimize the correction value.

10. A non-transitory computer-readable recording medium storing a program for causing a computer to execute processing comprising:
acquiring a text and an image to be compared;
calculating a score indicating a matching degree between the text and the image;
calculating a correction value of the score using a correction model, based on the image;
correcting the score using the correction value and outputting the corrected score; and
training the correction model in such a way as to optimize the correction value.
